(19) United States
(12) Patent Application Publication
(10) Pub. No.: US 2024/0002976 A1
(43) Pub. Date: Jan. 4, 2024

(54) METHOD FOR MELTING FERROUS METALS, NON-FERROUS METALS, MACHINING WASTE AND SCRAP AND STEEL

(71) Applicant: COMPAGNIA COMMERCIALE SRL, Como (IT)

(72) Inventor: Tommaso Brando CARPANETO, Arese (IT)

(21) Appl. No.: 18/255,702

(22) PCT Filed: Nov. 12, 2021
(86) PCT No.: PCT/EP2021/081517

§ 371 Date: Jun. 2, 2023

(30) Foreign Application Priority Data
Dec. 3, 2020 (IT) 102020000029678

(51) Int. Cl. C22B 9/10; C21C 7/00

(52) U.S. Cl. CPC C22B 9/103; C21C 7/0006; C21C 7/0025; C21C 2007/0062

(57) ABSTRACT

A method for melting ferrous metals, non-ferrous metals, machining waste and scrap and steel, includes the following steps of providing a closed container made of a material that is compatible with a melting bath in which it is to be placed and is adapted to contain materials adapted to be used as corrective substances in the melting bath; introducing the corrective substances in the container so as to obtain a closed container which contains the corrective substances; inserting the closed container in the melting bath; and monitoring the melting of the container and the release of the corrective substances in the melting bath.

### CROSS-REFERENCE TO RELATED APPLICATIONS

This application is a 35 U.S.C. § 371 National Stage patent application of PCT/EP2021/081517 filed 12 Nov. 2021, which claims the benefit of Italian patent application 102020000029678 filed 3 Dec. 2020, the disclosures of which are incorporated herein by reference in their entirety.

### TECHNICAL FIELD

The present disclosure relates to a method for melting ferrous metals, non-ferrous metals, machining waste and scrap and steel in foundries and steel plants. More particularly, the disclosure relates to a method for using iron alloys, recarburizing substances, corrective substances in general and machining waste/recovered materials in foundries of ferrous metals, non-ferrous metals and in steel plants.

### BACKGROUND

As is known, the furnaces in a foundry are mainly of three types:
Electric
Rotary
Cupola (coke-fired)

In steel plants instead they can be:
Electric
Blast furnaces (which means coke-fired, but in this case one speaks of first melting and not second melting as in an electric foundry or steel plant)

In general, electric furnaces and cupola furnaces are fed with cold product in a hot furnace (meaning with a high-temperature liquid base), while rotary furnaces are fed cold (they are filled when cold with cold product).

The energy vector is naturally different in the three furnaces:—
Electric—electric power
Cupola/Blast furnaces—Coke+Oxygen
Rotary—Oxygen+combustible gas.

The final product, whether ferrous (cast iron, steel) or non-ferrous (bronze, aluminum, etcetera) is always of a certain size/shape and having specific technical characteristics which determine its quality.

With the exception of steel plants with blast furnace, which work by means of a so-called “reduction” process with minerals, all the other forms of combustion perform a second melting process, i.e., they start from a product that has already been reduced (cast iron, HBI, DRI) or from a product that has completed its operational function (scrap) and is “remelted”.

In any process, the definition of the exact quality of the finished product is achieved by means of a so-called “correction” during melting, by using additions of iron alloys/metals/recarburizing substances in order to achieve the desired chemical analysis; these additions relate to a wide range of metallurgical elements, such as for example: carbon, sulfur, silicon, manganese, copper and many more.

All furnaces are fed with specific dimensions due both to a handling problem and to an oxidation/slag/management problem.

It is obvious that handling must be as automated as possible, therefore mechanical shovels, cranes, etcetera, and it is impossible to manage products in powder form in large quantities.

In addition to the above mentioned problem, non-sized products have a technical problem.

Any product in powder form is considerably subject to the circumstances of use and it is impossible for it to be able to transfer the technical characteristics to the melt liquid because it burns, oxidizes or is extracted by the extraction systems. Consequently, everything that is not sized correctly cannot be used or is subject to severe processing losses.

Basically, in foundries of ferrous metals, non-ferrous metals and in steel plants it is common practice to provide for the use of iron alloys, recarburizing substances, corrective substances in general and machining waste that must be added to the liquid metal/steel bath. These corrective substances are necessary in order to achieve a specific final chemical composition.

The addition of iron alloys, recarburizing substances, corrective substances in general and machining waste is currently performed by using materials at such temperatures that the corrective substances are exposed to the furnace flame or to combustion when the metal (whether ferrous or non-ferrous) is already molten.

This causes the drawback of having to use sized pieces for the corrective substances.

### SUMMARY

The aim of the present disclosure is to provide a method for foundries of ferrous metals, non-ferrous metals and for steel plants, in which the addition of iron alloys, recarburizing substances, corrective substances in general and machining waste to the metal can occur so as to optimize the chemical function of the corrective substances, protecting them from the flame and/or from oxidations.

Within this aim, the present disclosure provides a method for melting ferrous metals, non-ferrous metals, machining waste and scrap and steel in foundries and in steel plants in which it is possible to create a mixture of corrective substances to be added ready-made to the metal.
the present disclosure also provides a method for melting ferrous metals, non-ferrous metals, machining waste and scrap and steel in foundries and in steel plants that allows to manage the corrective substances in general like the raw material.
the present disclosure further provides a method for melting ferrous metals, non-ferrous metals, machining waste and scrap and steel in foundries and in steel plants that is highly reliable, relatively simple to provide and at competitive costs.

This aim and these and other advantages which will become better apparent hereinafter are achieved by providing a method for melting ferrous metals, non-ferrous metals, machining waste and scrap and steel, comprising the steps of:
providing a closed container made of a material that is compatible with a melting bath in which it is to be placed and is adapted to contain materials adapted to be used as corrective substances in said melting bath;
introducing said corrective substances in said container so as to obtain a closed container which contains said corrective substances;
inserting said closed container in said melting bath;
monitoring the melting of said container and the release of said corrective substances in said melting bath.

### DETAILED DESCRIPTION OF THE DISCLOSURE

Further characteristics and advantages of the disclosure will become better apparent from the description of a preferred but not exclusive embodiment, of the method according to the disclosure.

The method according to the disclosure provides for use in foundries of ferrous metals, non-ferrous metals and in steel plants.

The method is based on the creation of a container, suitable to be closed, of appropriate dimensions, made of new or recycled material, but in any case made of a metal that melts (and therefore allows the contact of a product/material contained therein, for example of a powdery type, which acts as a corrective substance) in the melting bath/liquid so that the container can release its contents without said contents undergoing the processes of heating or contact with oxygen (which causes oxidation).

In other words, the container is adapted to allow materials/corrective substances (generically referenced hereinafter as “corrective substances”) to be added to metal in a foundry or in a steel plant to be contained therein and be released as a result of the melting of said container.

Therefore, the container must be made of a material compatible with the melting bath in which it is to be placed. For example, an aluminum-melting bath must provide a container made of aluminum.

Such corrective substances (for example also materials in powder form), i.e., iron alloys, recarburizing substances, corrective substances in general and machining waste, are therefore placed in the above mentioned container, which is then inserted in the metal of the melting bath.

The container ensures that the products contained therein come into contact with the metal already in the semi-liquid state, thus avoiding being exposed to flame or combustion before the metal is molten (both if the metal is ferrous and if it is non-ferrous).

In this manner one obtains the extension of the time during which the alloys and the recarburizing substances remain protected from the flame and/or from oxidations, thus allowing their chemical function to take place directly in the liquid.

Possible corrective substances to be introduced in the above mentioned container are listed hereinafter.

Iron alloys—All iron alloys are selected by manufacturers by means of a screening process that sometimes is repeated in trader storage depots. The larger sizes (10-50 mm or larger) are used in the furnaces. The smaller sizes (3-10 mm) are used as a corrective substance in the ladle, i.e., the tool used to pour the already-molten liquid, and the small sizes (below 3 mm) currently have very low level uses.

Recarburizing substances—All products used for the addition of carbon are termed recarburizing substances. Since recarburizing substances are often combustible, their use is very delicate because it is difficult to get them to “work” in the liquid without burning and, since they are products with low physical strength, without breaking and being aspirated by the extractors.

Processing Cycles/Scrap/Waste

Fine products in general, ranging from those that foundries/steel plants themselves produce during processing to those produced by outside companies, for example steel/cast iron powders that currently need to be disposed since they have no applications.

Moreover, even in the case of extraction systems, all the powders collected by the filters have a content of recarburizing substances/alloys/iron that currently is disposed although it could be reused by means of the container described above.

It is also possible to provide all fine products in general that might relate to a metallurgical process to be used as corrective substances in powder form.

Therefore, a series of advantages is obtained. The use of the box is adapted and functional for all types of furnace: electric induction; rotary; cupola; arc and blast furnace.

The purpose is to increase the yield of iron alloys/metals/recarburizing substances/corrective substances, minimizing waste and scrap to be disposed.

It also allows the reduction of the ore and of the oxides in general. It also facilitates the management of slag by allowing the introduction of “fluxes” (limestone flux/lime/CaCO3 and similar products).

In particular, it allows the use of less valuable titers with less need for harmful emissions during production.

The container used in the method according to the present disclosure can be seen as a real melting furnace, which implies that the energy derives from its immersion in the melting bath and the heat is transferred by thermal conduction inside said container.

Consequently, by inserting the desired materials inside the container a chemical reaction is generated which is capable of reducing the oxides.

The possibility to add a calcareous flux directly in the furnace by means of the container helps to allow deslagging of the siliceous gangue.

In order to reuse a product with a high percentage of oxide, one proceeds as follows:
the container is filled with oxidized products (be they FeO2; SiO2; MnO2; A102; etcetera in all their forms) and a product with high carbon content, of fossil origin (fossil coal; coke; anthracite), plant-based origin (charcoal), natural origin, chemical origin (petroleum coke; graphite; etcetera), or residual origin (plastic; polymers; etcetera), is added also inside the container. The two products, thanks to the high temperature inside the container immersed in the melting bath, generate a chemical reaction of reduction (FeO2+C=Fe+CO2; SiO2+C=Si+CO2; . . . ); once the melting point has been reached, the container and its contents (Fe; Si; Mn; Al; . . . ) mix with the liquid in which they are immersed.

Another advantage of the method according to the present disclosure is also the fact that there is a reduced need for pieces of large size and it is possible to use even scrap in powder form, since by being protected by the container casing the materials cannot be aspirated by the filtering systems (saving on the quantity of material and spring the filtering system itself).

In addition, greater ease in handling is provided since the container can be managed like the raw material and handled by means of mechanical shovels without using large bags or paper bags (with obvious ecological savings in packaging).

Even further, the container can be filled with different materials at the same time, thus creating a mixture to be added ready-made, which saves in-house work and optimizes management.

In addition, with the method according to the present disclosure it is possible to use as corrective substances materials normally destined for disposal and it is also possible to obtain full utilization of the dust of filters of extraction systems before disposal of the residue as slag, therefore converting the waste which is essentially recycled, avoiding its disposal.

Still further, the method according to the present disclosure allows to recover a material destined for disposal, thus providing a recycling process, decreasing the energy and economic consumption due to disposal.

In practice it has been found that the method according to the disclosure fully achieves the intended aim and objects, since it allows to introduce iron alloys, recarburizing substances, corrective substances in general and machining waste in the metal to be melted.

The method thus conceived is susceptible of numerous modifications and variations, all of which are within the scope of the accompanying claims.

In practice, the materials used, as well as the contingent shapes and dimensions, may be any according to the requirements and the state of the art.

The disclosures in Italian Patent Application No. 102020000029678 from which this application claims priority are incorporated herein by reference.

1-4. (canceled)

5. A method for melting ferrous metals, non-ferrous metals, machining waste and scrap and steel, the method including the following steps:
providing a closed container made of a material that is compatible with a melting bath in which said container is to be placed, said container being configured to contain materials adapted to be used as corrective substances in said melting bath,
introducing said corrective substances in said container so as to obtain a closed container which contains said corrective substances,
inserting said closed container in said melting bath, and
monitoring melting of said container and release of said corrective substances in said melting bath.

6. The method according to claim 5, wherein said corrective substances comprise iron alloys, recarburizing substances, fine products derived from waste of metallurgical processes.

7. The method according to claim 5, wherein said corrective substances comprise materials in small pieces.

8. The method according to claim 5, wherein said corrective substances are inserted in said container in order to also obtain a mixture.
